(19) United States
(12) Patent Application Publication
(10) Pub. No.: US 2026/0231862 A1
(43) Pub. Date: Aug. 13, 2026

(54) REARWARD PIVOTING ASSEMBLY FOR A GROUNDS CARE VEHICLE

(71) Applicant: Jonathon Scott Terlouw, Sully, IA (US)

(72) Inventor: Jonathon Scott Terlouw, Sully, IA (US)

(21) Appl. No.: 19/532,445

(22) Filed: Feb. 6, 2026

Related U.S. Application Data
(60) Provisional application No. 63/755,869, filed on Feb. 7, 2025.

(51) Int. Cl. A01D 67/00; A01D 69/00; A01D 101/00; B62D 51/02

(52) U.S. Cl. CPC A01D 67/00; A01D 69/00; B62D 51/02; A01D 2101/00

(57) ABSTRACT

A rearward pivoting assembly improves operator ride quality and mower serviceability. The longer distance of the pivot to the support method under the operator reduces vibrations and forces to the operator. When the assembly is pivoted rearward; the engine, belts and deck become serviceable. The inverted assembly can be leveraged to lift the front end. In addition, the front of the machine is more easily lifted having the machine center of gravity above or behind the rear wheel axis. The formed frame provides the offset and mounting locations of the engine, engine enclosure, controls, deck, rear drive wheel transaxle, belt drivetrain sheave alignment and clearance holes for servicing components below the frame.

### CROSS-REFERENCE TO RELATED APPLICATIONS

This application claims priority to U.S. Provisional Patent Application No. 63/755,869 filed on Feb. 7, 2025, the entirety of which is hereby incorporated herein by reference.

### FIELD OF THE DISCLOSURE

This disclosure relates to a rearward pivoting assembly aiding in operator seat suspension and servicing the engine or the underbody of a vehicle such as a mower.

### BACKGROUND OF THE DISCLOSURE

Zero-turn mowers are generally configured with an operator seat above the mower deck and ahead of the rear axle and engine. Factors such as the suspension, seat, mount, design geometry, pivot location and support features being rigid, spring, rubber, airbag all affect operator ride quality. Generally, shorter suspension and rigidity cause operator fatigue from terrain, speed, or forces transferred through the chassis.

Typical provisions for seat removal or forward pivoting to gain access to the engine are used occasionally for servicing the engine or belts i.e.. drivetrain. Engine service points include oil level, filters (oil, air, fuel), levers, pistons, sheaves, and various others recommended in the operator's manual. Most service operations are rainy day projects or scheduled at a location of purchase or service center-ideally an environmentally friendly space with proper tools and lighting. However, some inspections and/or service may need to occur on the owner or customer's jobsite or yard in a moment's notice with limited or no tools.

On a regular and recommended basis, it is necessary to replace belts or sharpen grass cutting blades below the deck-the enclosure of rotating blades and cuttings path control. Servicing of blades or removal of built-up material cuttings for example, typically requires jacks, hoist, lifts, props, tools or removal of pins and a significant amount of time to prepare access. Mower owners and service technicians will otherwise fully remove the deck with more force or raise the complete machine with expensive lifting equipment to gain access.

Blade sharpening frequency can depend on the acres of grass, regionally different to climate, stem diameter, moisture, cutting height, presence of sand/gravel/debris, blade quality and operator preferences. A well-maintained mower can enhance performance, longevity, safety, contractor's customer satisfaction and re-sale value.

For the reasons stated above, and for other reasons which will become apparent to those skilled in the art upon reading and understanding the specification, there is a need in the art for improving access to service items and operator ride quality. Thus, it is a primary object of the disclosure to provide a rearward pivoting assembly for a vehicle such as a zero-turn riding lawn mower.

These and other objects, features, or advantages of the present disclosure will become apparent from the specification and claims.

### BRIEF SUMMARY OF THE DISCLOSURE

The disclosure relates to an assembly or frame which pivots about a point located at an upper and rearmost location on the mower chassis or engine enclosure frame. The rearward pivoting assembly of a zero-turn mower or similarly configured machine thus extends ahead of the engine. The rearward pivoting assembly may be supported at its front end by a shock absorbing mechanism. The shock absorbing mechanism may comprise UHMW (Ultra-high-molecular-weight polyethylene aka durable plastic) material, spring, rubber, an airbag another shock absorbing device or material, or some combination placed under the operator's seat or center of gravity for the purpose of reducing shock loads and forces to the operator. The span of which enhances operator seat suspension and ride qualities. Additionally, a latch or tether can be released to pivot the rearward pivoting assembly rearward up to 150 degrees with mechanical assistance (i.e. torsion spring or compressed gas cylinder) as needed where it rests again on the machine structure. Sensors or switches may be incorporated into the rearward pivoting assembly location or release mechanism for limiting operations similar to Engine Stop, fuel off, or power disconnect.

When pivoted, the rearward pivoting assembly and weight thereof displaced to the rear moves the machine center of gravity more directly over the rear wheel axis. The rearward pivoting assembly being somewhat inverted can then be leveraged downward, lifting the front of the machine until rear structure touches the ground. It is desirable to require less than 80 pounds force to begin lifting front of machine. These features give access to engine, belts, drivetrain, deck, and cutting blades in less than a minute with no tools. The tilted angle of the chassis and deck up to 40 degrees is achieved while machine is nearly balanced on level surface. Propping is not required to maintain the tilted maintenance position of the machine; however, optional propping may be added for additional stability. This disclosure depicts a zero-turn mower tilted for access to deck blades, belts, linkages, and maintenance areas with the rearward pivoting assembly inverted rearward.

### BRIEF DESCRIPTION OF THE DRAWINGS

FIG. 1 depicts a side view of a rearward pivoting assembly installed on a mower in an operating position according to one embodiment.

FIG. 2 depicts a side view of a rearward pivoting assembly installed on a mower and pivoted rearward according to one embodiment.

FIG. 3 depicts a side view of a rearward pivoting assembly installed on a mower in a maintenance position according to one embodiment.

FIG. 4 depicts a side view of a rearward pivoting assembly in a partially raised position according to one embodiment.

FIG. 5 depicts a rear perspective view of a rearward pivoting assembly installed on a zero-turn mower designed for mowing or mulching grass in residential yards, ditches, municipal or commercial turf, etc. according to one embodiment.

FIG. 6 depicts a rear view of a rearward pivoting assembly installed on a mower according to one embodiment.

FIG. 7 depicts a rear perspective view of a rearward pivoting assembly in a raised position according to one embodiment.

FIG. 8 depicts a front view of a rearward pivoting assembly installed on a mower according to one embodiment.

FIG. 9 depicts a top view of a rearward pivoting assembly installed on a mower according to one embodiment.

FIG. 10 depicts a caster wheel assembly connecting parts of a frame according to one embodiment.

FIG. 11 depicts a perspective view of a rearward pivoting assembly in a raised position according to one embodiment.

FIG. 12 depicts a side view of rearward pivoting assembly pivoted past a roll over protection system in its operating position according to one embodiment.

FIG. 13 depicts a torsion spring of a rearward pivoting assembly in its maintenance position according to one embodiment.

FIG. 14 depicts a torsion spring of a rearward pivoting assembly in its maintenance position according to one embodiment.

FIG. 15 depicts a torsion spring of a rearward pivoting assembly in its operating position according to one embodiment.

FIG. 16 depicts a side view of a torsion spring of a rearward pivoting assembly in its operating position according to one embodiment.

FIG. 17 depicts a foot pan latch assembly in operating position according to one embodiment.

FIG. 18 depicts a foot pan latch assembly in maintenance position according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized, and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description and are not intended to be used as limitations. Accordingly, orientation of an object or a combination of objects may change without departing from the scope of the disclosure.

A rearward pivoting assembly 2 suitable for attachment to outdoor power equipment such as a mower 1 or similar vehicle or implement is disclosed. The terms mower 1, vehicle 1, implement 1, ride-on implement 1, outdoor power equipment 1, grounds care equipment 1, or equipment 1 may be used interchangeably without departing from the scope of the disclosure. The rearward pivoting assembly 2 may alternatively be referred to as rear pivoting seat assembly 2, seat assembly 2 or assembly 2 without departing from the scope of the disclosure. While the rearward pivoting assembly 2 is shown and described in the context of a zero-turn mower 1, the rearward pivoting assembly 2 may be used with any similar vehicle or implement without departing from the scope of the disclosure. For example, the rearward pivoting assembly 2 may be installed on a zero-turn mower, stand-on mower, another type of mower, dethatching implement, golf ball collector, outdoor power equipment, all-terrain vehicle, ice maintainer, sweeper, or other similar vehicle or implement for which increased operator comfort or serviceability are desired. The system could be used on any such vehicle in which the majority of the weight can be shifted to the opposite side of the drive wheels as a means to service the vehicle 1.

A typical riding mower 1 comprises a mower frame 101 transaxle 103 and rear wheels 102, front wheels assembly 108, roll-over protection system (ROPS) 104, engine 105, deck 107, fuel cell, battery, and miscellaneous operating or suspension mechanisms.

Rearward pivoting assembly 2 provides for a smoother ride experience due to placement of a pivot axis 207 well behind the operator location to carry the operator weight on a longer span, torsion springs 220 about the pivot axis 207, and compression springs or other cushioning component at the front portion of the operator location.

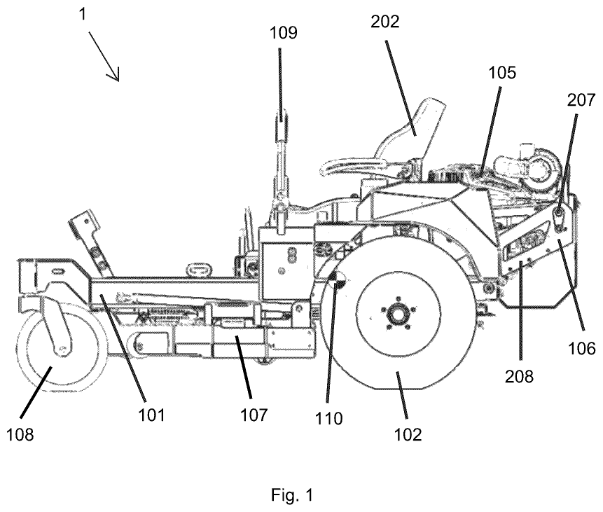

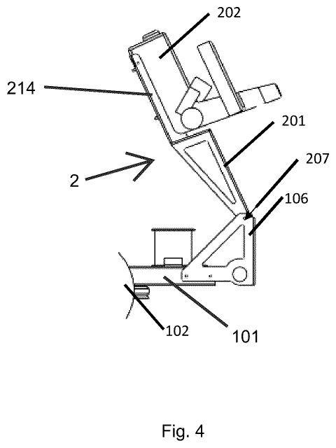

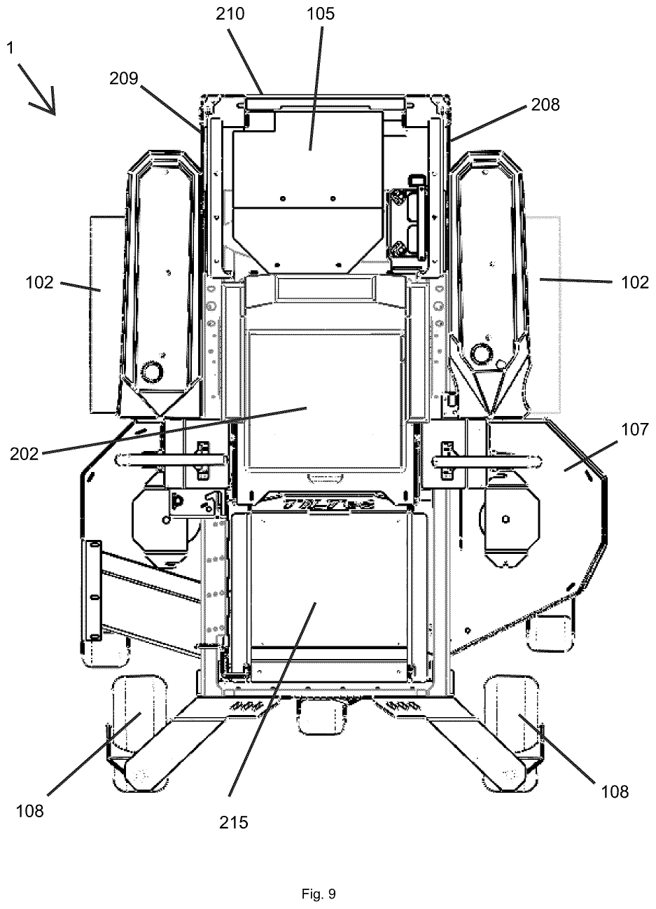

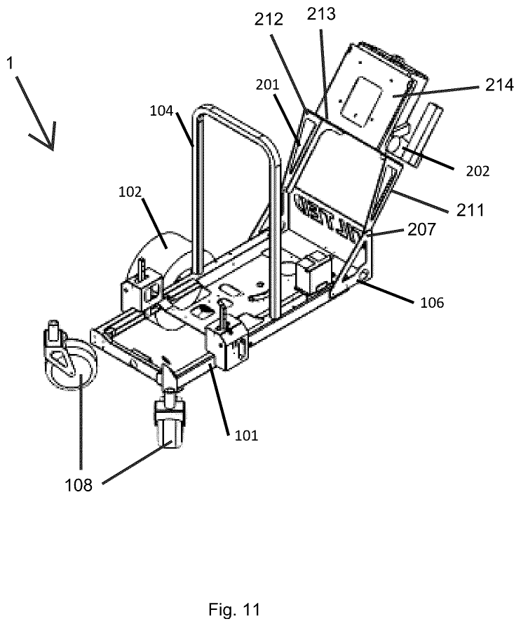

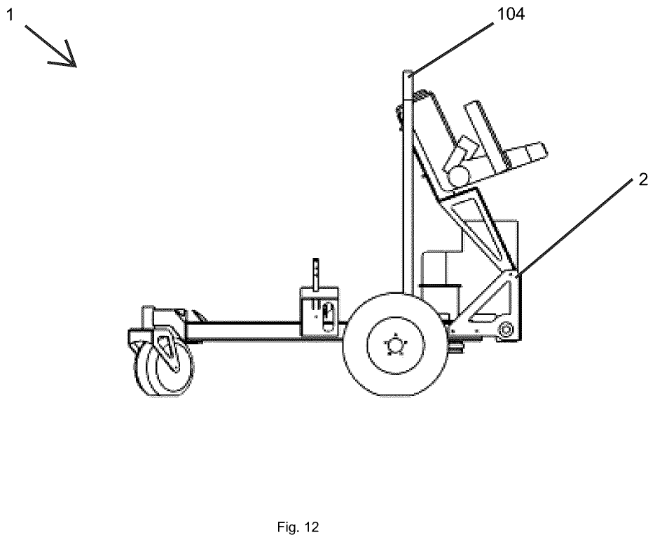

As shown in FIGS. 1-12, in one embodiment, a rearward pivoting assembly 2 suitable for installation on a mower 1 comprises an engine enclosure 106 and a seat frame 201.

In one embodiment, the engine enclosure 106 is a stationary structure secured to the mower frame 101. The engine enclosure 106 provides a stationary structure for mounting, supporting, pivoting, lift assist, and leveraging the rearward pivoting assembly 2. The shape of the engine enclosure 106 also provides a stopping mechanism for when the mower 1 is tilted into the maintenance position. The lower rear portion of the engine enclosure 106 is angled such that the engine enclosure rests on the ground and the angled portion of the engine enclosure 106 sits flat on the ground. The size, shape or features of engine enclosure 106 or seat frame 201 may be customized without departing from the scope of the disclosure.

The engine enclosure 106 may comprise a first side 208 and a second side 209. The first and second sides 208, 209 of the engine enclosure 106 may be generally right triangular shapes or generally trapezoidal shapes; however, the first and second sides 208, 209 may each be any other shape without departing from the scope of the disclosure. The opposing first and second sides 208, 209 of the engine enclosure 106 may be joined by an engine enclosure back surface 210. The engine enclosure back surface 210 may be a generally rectangular shape in which a first side of the engine enclosure back surface 210 engages and connects to the rearmost end of the first side 208 of the engine enclosure 106, and a second side of the engine enclosure back surface 210 engages and connects to the rearmost end of the second side 209 of the engine enclosure 106 such that the engine enclosure back surface 210 is generally perpendicular to the first and second sides 208, 209 of the engine enclosure 106 and the first and second sides 208, 209 of the engine enclosure 106 are opposing to each other and are generally parallel to each other. The first and second sides 208, 209 of the engine enclosure 106 may feature interior cutouts. The engine enclosure 106 may be formed from one piece of material, or separate components may be joined together to form the engine enclosure 106 using welding, fasteners, or another suitable connection means. The engine enclosure 106 may be constructed from steel, or alternative metal types, or another suitable material.

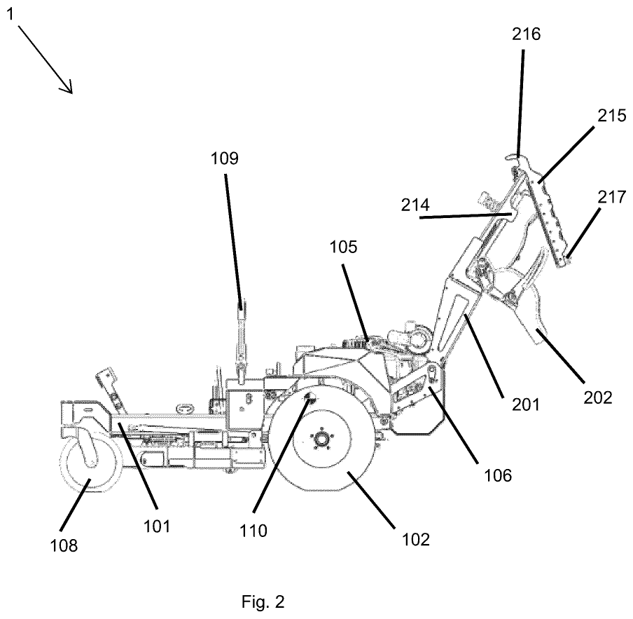

In one embodiment, the seat frame 201 is a movable structure having a rear end that mounts to the engine enclosure 106 at pivot axis 207 and a front end that attaches to the mower frame 101 using a latch 217 or tether. The pivot axis 207 is located behind the seat 202 and engine. Pivot axis 207 connects the seat frame 201 to the engine enclosure 106 such that the rearmost position of the seat frame 201 is secured to the engine enclosure 106 at the pivot axis 207 disposed at an uppermost and rearmost position of the engine enclosure 106. The seat frame 201 is capable of rotating about the pivot axis 207 between a lowered operating position as shown in FIGS. 1, 5, 6, and 9 and raised to a tilted or maintenance position as shown in FIGS. 2-4, 7, 8, 11, and 12. The seat frame 201 provides a platform for mounting the operator seat 202. When the seat frame 201 is rotated into the tilted or maintenance position, the center of gravity 110 of the mower 1 shifts such that the front end of the mower 1 can be lifted off the ground for maintenance. The seat frame 201 may comprise a first side 211 and a second side 212. The first and second sides 211, 212 of the seat frame 201 may be generally right triangular shapes. The first and second sides 211, 212 of the seat frame 201 may be joined by a seat frame front surface 213. The seat frame front surface 213 may be a generally rectangular shape in which a first side of the seat frame front surface 213 engages and connects to the forwardmost end of the first side 211 of the seat frame 201, and a second side of the seat frame front surface 213 engages and connects to the forwardmost end of the second side 212 of the seat frame 201 such that the seat frame front surface 213 is generally perpendicular to the first and second sides 211, 212 of the seat frame 201 and the first and second sides 211, 212 of the seat frame 201 are generally parallel to each other. A platform 214 extends forwardly from the seat frame front surface 213. The platform 214 may comprise a generally horizontal planar surface to which the seat 202 is mounted. A rear-most edge of the platform 214 attaches to the seat frame front surface 213 and extends forwardly. In one embodiment, a forward-most edge of the platform 214 attaches to a rear-most edge of the footpan 215. If no footpan 215 is present, then in another embodiment the forward-most edge of the platform 214 attaches to a latch 217 or tether.

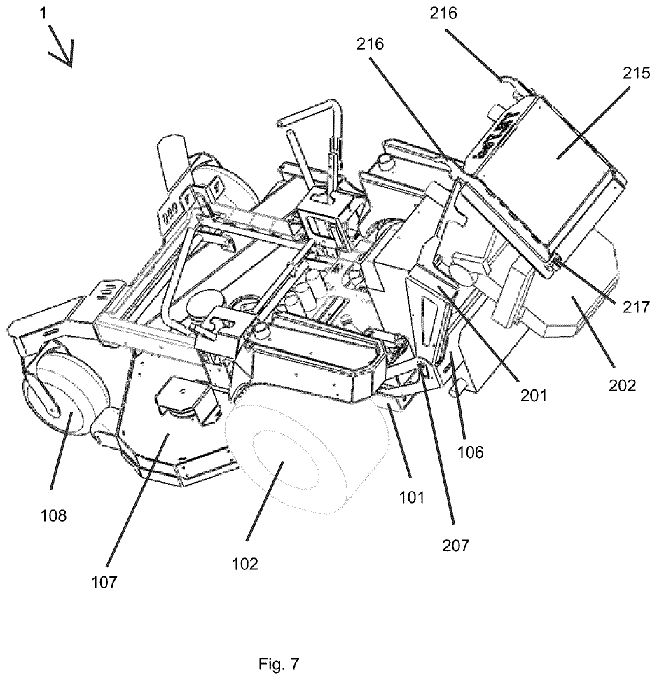

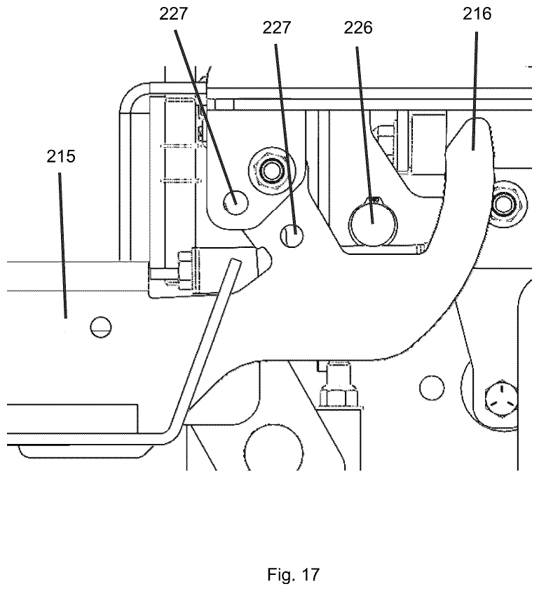

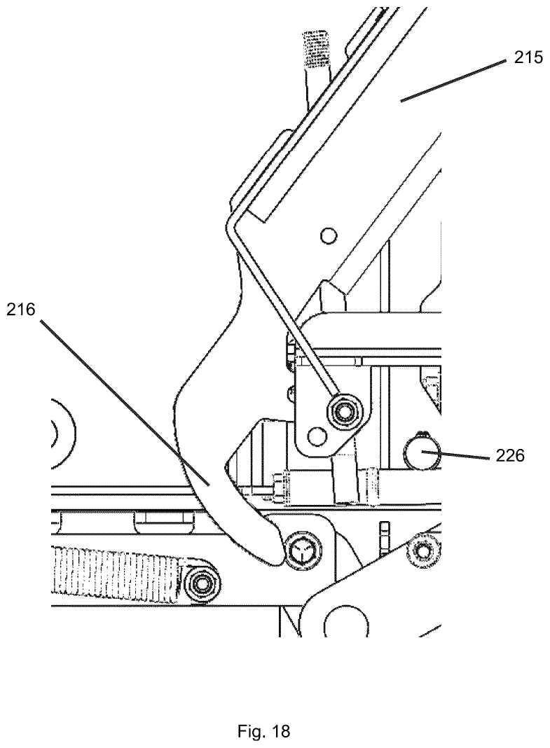

A footpan 215 hingedly attaches to the forward-most edge of the platform 214. Footpan 215 may comprise a generally horizontal planar surface. Footpan 215 provides a surface for safe placement of the operator's feet while operating the mower 1. Footpan 215 also has a role in securing the seat frame 201 securely down while the mower 1 operates. Additionally, bushings or rubber isolators may be placed at the front corners of footpan 215 to improve ride quality by suspending the platform 214. As shown in FIGS. 2, 3, 7, 17, and 18, footpan 215 may feature one or more hooks or generally C-shaped retaining members 216 disposed at or near a rear-most edge of the footpan 215. As shown in FIG. 7, in one embodiment, two hooks or C-shaped retaining members 216 are provided, one on each side of the footpan 215 and extending past the rear-most edge of the footpan 215. Footpan 215 may also feature a bar along the forward-most edge of the footpan 215, assisting in lifting footpan 215 when the latch 217 is released, and providing something to hold onto while moving the mower 1 between operating and maintenance positions. Footpan 215 is lowered for operation of mower 1 as shown in FIG. 17, and in the lowered operating position footpan 215 lies generally horizontally along the same plane as the platform 214 and seat frame 201. In operating position, one or more latches 217 disposed at the forward-most edge of the footpan 215 are secured to the mower frame 101, and the opening of the C-shaped retaining members 216 is generally upward such that the closed portion of the C-shaped retaining members 216 surround a stationary shaft 226 on the mower frame 101. With the latches 217 engaged and closed portion of the C-shaped retaining members 216 surrounding the stationary shaft 226 on the mower 1, movement of the rear-pivoting seat assembly 2 and its individual components is prevented. The stationary shaft 226 that engages and retains the retaining members 216 may be the park brake shaft. To place the mower 1 in maintenance position, the latch 217 at the forward-most edge of footpan 215 is released, allowing footpan 215 to pivot about a generally horizontal axis at or near the rearmost edge of the footpan 215. As footpan 215 is pivoted, the relative position of the opening in the C-shaped retaining members 216 changes until the opening in the C-shaped retaining members 216 is generally downward, releasing the grasp of the C-shaped retaining members 216 from the stationary shaft 226 on the mower frame 101. Thus, with footpan 215 fully pivoted back as shown in FIG. 18, rear pivoting seat assembly 2 may be lifted to place the mower 1 in the state depicted in FIG. 2 where the rear-pivoting seat assembly 2 is tilted rearward, but the mower 1 has not yet been tilted into maintenance position. Pivoting of the footpan 215 not only assists with securing and releasing the assembly 2, but folding the footpan 215 back also aids with allowing the assembly 2 to clear a ROPS 104. Footpan 215 may also feature one or more lock pin holes 227. By placing a pin or similar item through the lock pin holes 227, the lock pin holes 227 allow the footpan 215 to be locked down, locked up to work on the deck 107 without pulling the whole assembly 2 back, and locked out for extra torque when the deck 107 is full of grass.

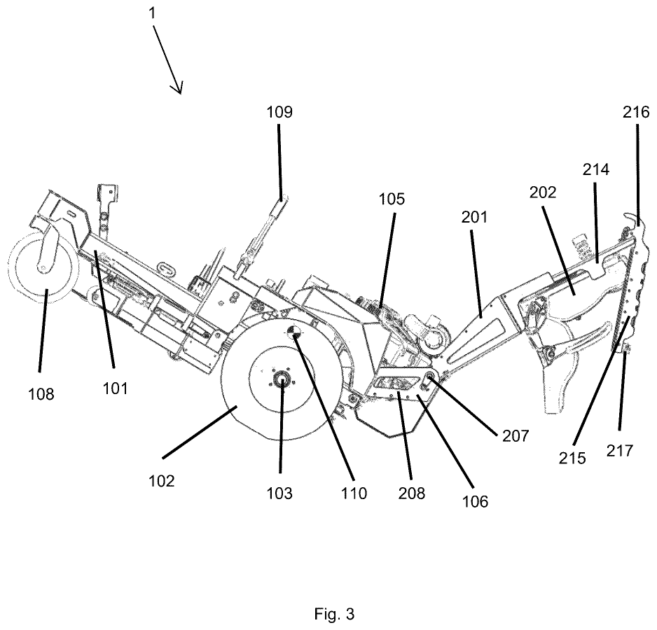

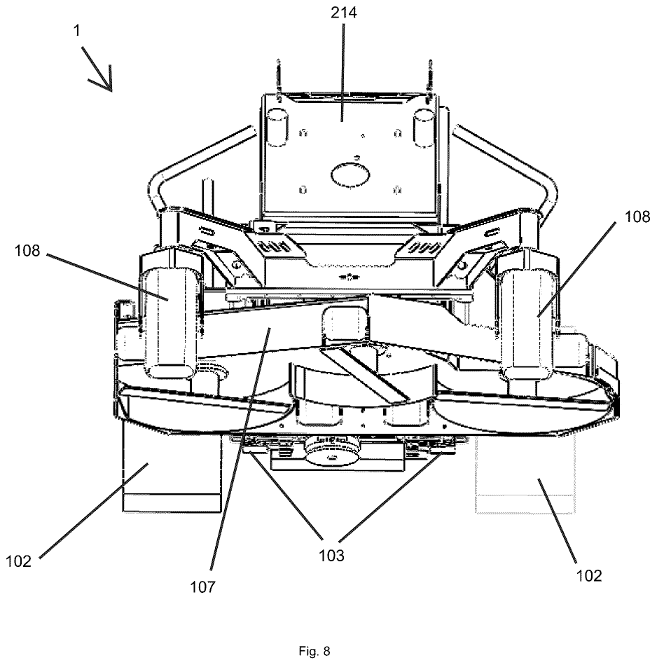

With the footpan 215 fully pivoted, an operator may then push downward on the rearwardly tilted assembly 2 until the forward-most end of the mower 1 is raised off the ground, placing the mower 1 in maintenance position as shown in FIGS. 3 and 8, and the underside of mower 1 can be accessed. As such, one person can easily, without tools, tilt a mower 1 into a maintenance position in which the operator has unobstructed access to the underside of the mower 1.

The partially tilted state depicted in FIG. 2 where the rear-pivoting seat assembly 2 is tilted rearward, but the mower 1 has not yet been tilted into maintenance position may be used advantageously. In this state, rear-pivoting seat assembly 2 can be flipped up part way and the control levers 109 of mower 1 folded inward such that the platform 214 rests on the control levers 109; thus areas under the platform 214 can be serviced without the need for external tools. This technique also allows a shorter person to raise the mower 1 into maintenance position more easily as the assembly 2 can be secured part-way at the side of the mower 1, move behind the mower 1, and complete tipping the mower 1 into maintenance position.

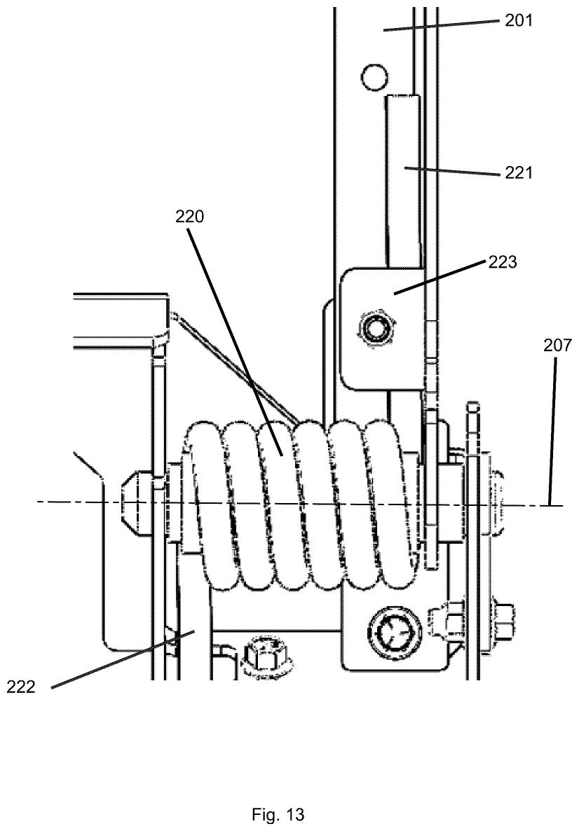

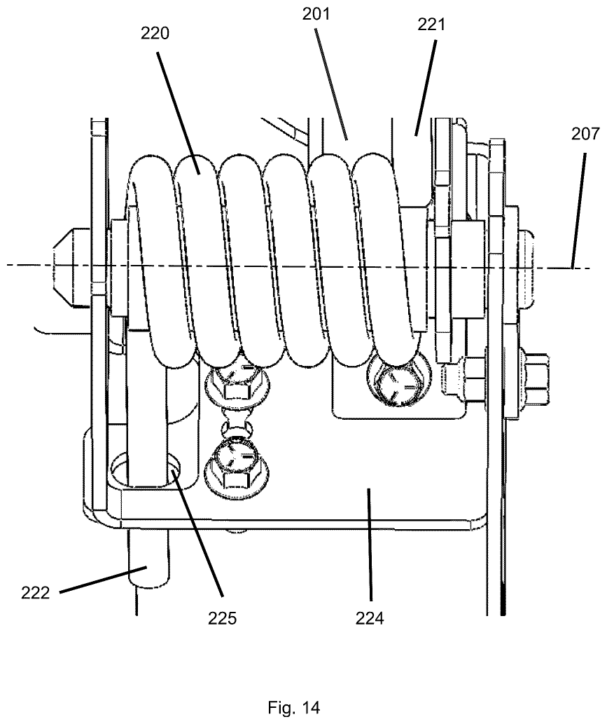

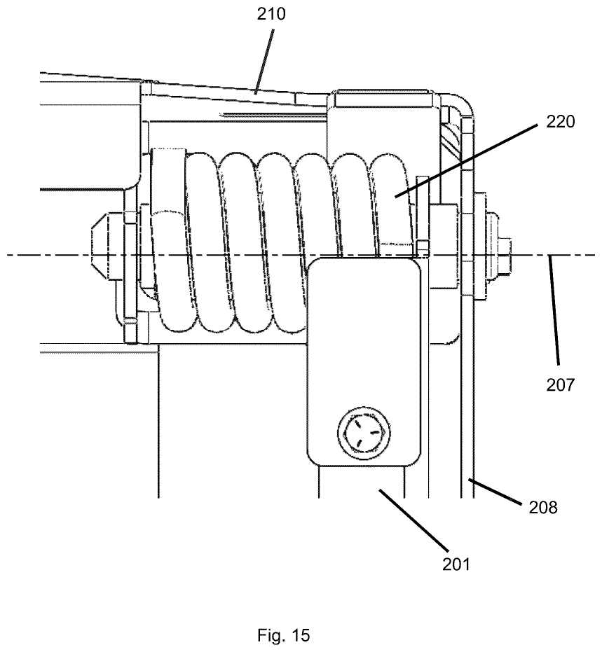

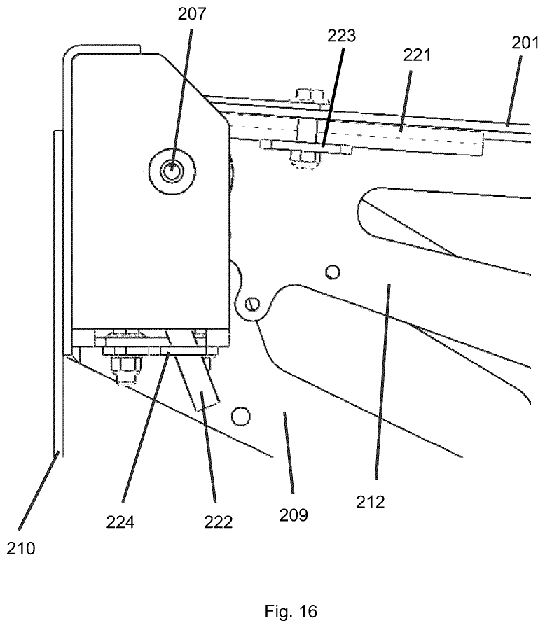

As shown in FIGS. 13-16, transitioning the rear pivoting seat assembly 2 and mower 1 between maintenance and operating positions may be aided by use of one or more torsion springs 220 disposed at and rotating about the pivot axis 207. The torsion springs 220 may be clocked at an angle within the range of 150 to 180 degrees. In one preferred embodiment, the torsion springs are clocked at 160 degrees. The torsion spring 220 is depicted in FIGS. 13 and 14 in maintenance position. The torsion spring 220 is depicted in FIGS. 15 and 16 in operating position. Use of a torsion spring 220 creates torque that makes it easier to transition between maintenance and operating positions. A first leg 221 of the torsion spring 220 contacts the seat frame 201, aligning with the platform 214. For example, the first leg 221 may contact the first side 211, second side 212, or another part of the seat frame 201. A keeper 223 rigidly attached to the seat frame 201 may contact the first leg 221 of the torsion spring 220 on the side of first leg 221 opposite to the side of the first leg 221 that contacts the seat frame 201. The keeper 223 maintains proper positioning of the first leg 221. A second leg 222 of the torsion spring 220 contacts the engine enclosure 106, aligned in a generally vertical orientation. For example, the second leg 222 may contact the engine enclosure first side 208, engine enclosure second side 209, another part of the engine enclosure 106, or a stationary surface of the mower frame 101 such that the second leg 222 is held generally vertically and the torsion spring 220 rotates about the pivot axis 207. A plate 224 attached to the engine enclosure 106 may contact the second leg 222 of the torsion spring 220 and allow the position of the second leg 222 to be adjusted. The second leg 222 may pass through a hole 225 formed in plate 222. The hole 225, being larger than the diameter of the second leg 222, allows movement of the second leg 222 within the hole 225. Such adjustment is important because torsion springs 220 are frequently shipped with a manufacturing tolerance, making fine adjustments necessary during installations to ensure that the torsion spring 220 goes over center. For example, a torsion spring 220 specified by the manufacturer at 168 degrees with a +/1 10% tolerance may be used to fit in the adjustment range. Such adjustment also allows fine tuning for a particular user as users of different statures may want slightly different behaviors in the performance of torsion spring 220. When the mower is in operating position as shown in FIGS. 1, 15, and 16, for example, the torsion spring 220 is in its fully loaded position. In the fully loaded position, an angle of approximately 80 degrees exists between the first leg 221 and the second leg 222 of the torsion spring. As the rear-pivoting seat assembly 2 is rotated, the torsion spring 220 unwinds in a first direction, aiding in lifting the assembly 2. As shown in FIGS. 13 and 14, when the platform 214 of the rearward-pivoting seat assembly 2 is generally vertical, the torsion spring is in its neutral position. When the torsion spring 220 is in its neutral position, an angle of approximately 160 degrees exists between the first leg 221 and the second leg 222 of the torsion spring. At the free or neutral position, the center of gravity 110 shifts, and the torsion spring 220 starts unwinding in a second direction that is opposite to the first direction. Thus, the described positioning of the torsion spring 220 allows the spring to be used in both its clockwise and counterclockwise directions of rotation, providing for a softer landing of the mower 1 as it is moved between operating and maintenance positions. While a torsion spring 220 is described for handling the load during transitions, other methods including a gas spring, gas dampener, air cylinder, hydraulic cylinder, electric actuator, or another similar device could be used without departing from the scope of the disclosure.

Because of the tilting nature of the disclosed mower 1 and rear-pivoting seat assembly, additional considerations are made for safety of the fuel tank. In the disclosed embodiments, it is preferable to place the sump of the gas tank at or near the rear of the mower 1. Such placement of the sump makes it possible to see the mower deck 107 while operating the mower 1. It is also preferable to make the rear sump front-filling for safety purposes. Most existing mowers are front sump, rear fill, and when such an arrangement is tipped back, for example to sharpen mower blades, fuel from the sump goes to the back toward the fuel cap If the cap is off or leaks in this situation, there are safety concerns, particularly if blades are being sharpened as sparks are generally present that can ignite leaked fuel. In the instant embodiment, by making the rear sump and front fill, fuel goes away from the cap when the mower 1 is tilted, increasing safety.

A load carrying member may be installed under the seat 202, providing smooth ride characteristics and transfer of weight and obstruction items for servicing the vehicle 1. The first and second sides 211, 212 of the seat frame 201 may feature interior cutouts. The first and second sides 211, 212 of the seat frame 201 and the seat frame front surface 213 may be formed from one piece of material, or separate components may be joined together to form the seat frame 201 using welding, fasteners, or another suitable connection means. The seat frame 201 may be constructed from metal or another suitable material.

While the engine enclosure 106 as described is a separate component of the rearward pivoting assembly 2, in other embodiments the seat frame 201 and other moving components of the rearward pivoting assembly 2 may mount directly to the mower frame 101 or another stationary and stable mounting point on the mower 1.

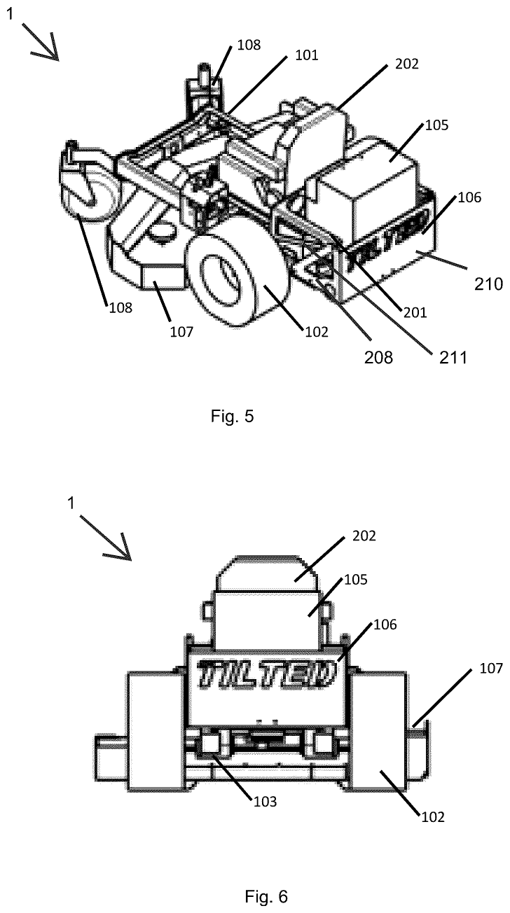

The rearward pivoting assembly 2, as shown in FIG. 5, has a common axis with the rear engine enclosure 106, ideally parallel to the transaxle 103, for pivoting about pivot axis 207 on bolts, bushings, bearings or other round materials. The seat frame 201 extends forward to secure the operator's seat 202. The seat assembly 2 may comprise a seat frame 201, operator seat 202, and may feature noise abatement, safety interlocks, a latching mechanism or lift assist along with a plurality of shock absorbing support items mounted to the seat frame 201 or mower frame 101. The seat frame 201 may include the operator foot rest or foot platform and operating controls. The foot platform may comprise a generally horizontal surface where a rear edge of the foot platform connects to a forward edge of the generally horizontal platform 214 of the seat frame 201 and extending forwardly. The seat frame or 201 foot platform may pivot rearward independently at a location behind the center of the seat 202 at a pivot on the mower frame 101. The rearward pivoting seat assembly 2 may include a safety interlock that disables operation of the engine 105 when the rearward pivoting seat assembly 2 or any of its components are raised from operating position. With engine off, the latch 217 can be released and the seat frame 201 can be pivoted past the Roll Over Protection System (ROPS) 104 as depicted in FIG. 12. An optional lift assist member, i.e. torsion spring or compressed air cylinder, can reduce the lifting force and otherwise control the rate of pivoting the seat frame 201. The seat frame 201 in its rearmost pivoted position contacts the rear engine enclosure 106, also serving as leverage to cantilever the mower 1 around the rear wheels 102. With the seat frame 201 raised, the area under the seat frame 201 and front side of engine 105 are fully accessible for maintenance. Movement of the seat frame 201 between the operating and maintenance positions does not interfere with the ROPS 104 or operator controls of the vehicle 1.

In conjunction with the rear pivot seat assembly 2, a safety mechanism such as a kickstand may be attached to the mower frame 101 or another suitable location on the mower 1. While the rearward rotation of the rear pivoting seat assembly 2 is sufficient to raise and maintain the mower 1 in the raised maintenance position, the safety mechanism or kickstand, extending between the mower frame 101 and the ground, would provide further support for the mower 1 in the raised position. In one embodiment, the static weight of the seat frame 201 is 70 pounds with a center of gravity 110 located approximately 30 inches ahead of the pivot axis 207 in operating position. When the seat frame 201 is released at its front edge, the initial force is 50 pounds at 42 inches. As the seat frame 201 pivots upward, the horizontal distance decreases, reducing the vertical force required to maintain momentum until going over center and becoming fully pivoted. When working with a heavier seat frame 201 or disproportionate leverage a ballast or lift assist mechanism with linear or torsional forces can be utilized to reduce lift forces. The lift assist mechanism may comprise a lift assist gas shock or another suitable mechanism. In some embodiments, the operator seat 202 does not touch the ground when the rearward pivoting assembly 2 is tilted back, placing the vehicle 1 in the maintenance position. With the seat frame 201 in a raised or maintenance position, the mower 1 can be pivoted around the rear wheel axis 102 as depicted in FIGS. 2-4, 7, 8, 11, and 12. Tilting about the rear wheel axis 102 is allowed by the unrestrained internal rotation of the transaxle 103 while the rear wheels 102 remain unmoved. If brakes are applied, the rear wheel/tire 102 against the ground becomes the fulcrum. While pushing downward on the inverted seat frame 201 or lifting the front of the mower 1, the underside of the deck 107 may be accessed. The access angle achieved is only limited by the engine enclosure 106 or obstructions, preferably not the seat frame assembly 201. The seat frame 201 pivots rearward until constrained by a lift assist, cushion rests, or the upper rearmost surface or edge of the mower frame 101 or engine enclosure 106 parallel to the pivot axis 207. This provides a serviceability condition underneath the seat 202 and front side of engine 105. The transfer of seat frame 201 weight rearward beyond the vehicle's 1 rear most extremity moves the center of gravity 110 of the vehicle 1 over the rear wheels 102. This allows for tipping the vehicle 1 around the rear wheel axis 102 with little effort providing serviceability to the underside of the vehicle 1 and its attachments. With the mower 1 in the tilted or maintenance position,, the underside of the deck 107 and its cutting blades are now serviceable.

As can be seen in FIGS. 1-3, the center of gravity 110 of the mower 1 shifts as the assembly 2 and mower 1 are moved into the various positions made possible by the assembly 2. As seen in FIG. 1, the assembly 2 is lowered to its operating position, and the mower 1 is likewise in its operating configuration. In operating position, the center of gravity 110 is lower and farther forward than in the other configurations. As seen in FIG. 2, the assembly 2 is tilted into its maintenance position, but the mower 1 has not been tilted back. In this configuration, the center of gravity 110 has shifted rearward and upward as compared to operating position. As seen in FIG. 3, the assembly 2 is in its maintenance position and the mower 1 has been tilted back to a maintenance position in which the underside of the mower deck 107 is accessible for maintenance. In this maintenance position, the center of gravity 110 again shifts upward and rearward. The various locations of the center of gravity 110 depicted are shown as examples based on the embodiment of the mower 1 and assembly 2 shown; however, the precise locations of the center of gravity 110 in the various configurations of mower 1 and assembly 2 may differ if the construction of the mower 1 or assembly 2 changes. In one embodiment, as one example, the static weight of the mower 1 may be approximately 1000 pounds with a center of gravity 110 located at approximately 10 inches ahead of the transaxle 103 in operating position. With the seat frame 201 pivoted rearward the mower 1 center of gravity 110 may moves to 3.2 inches ahead of the transaxle 103. Assuming the operator stands in front and lifts the front edge of the mower 1, the initial force is 80 pounds at 40 inches. Once pivoted rearward to the maintenance position, less than 20 pounds of force are required to maintain the vehicle 1 in the maintenance position when the vehicle 1 is on a level surface. Alternatively, and preferably, the operator can pull/push down on the inverted seat frame 201 with 50 pounds at 64 inches behind the transaxle 103. When working with a heavier seat frame 201 or disproportionate leverage a ballast or leverage tool can be utilized to reduce lift forces. As the mower 1 tilts rearward, the center of gravity 110 shifts to be located at approximately 3.2 inches ahead of the transaxle 103. Ideally coming to rest with the lower rearmost point of the mower 1 on the ground while minimal force or support is required to maintain the tilted service position on level ground (even less on favorable slope).

The further the seat frame pivot axis 207 is behind the rear wheel 102 axis, the greater the seat frame 201 weight balances the mower 1 around the rear wheel 102. Because the distance between where the seat 202 pivots and the springs determines ride quality or comfort of the operator, the disclosed design provides for improved ride quality and comfort. Further, placement of the pivot axis 207 far behind the operator station and suspension components at the front of the frame 201 under the operator seat 202 enhances the ride qualities of stability and shock absorption.

Returning the front wheels 103 to the ground and pivoting seat frame 201 forward returns the mower 1 to the operating position without tools in a short amount of time, requiring little effort in performing the inverse of the method described above. Manual force may vary on vehicle 1 options, ballasts, imbalance or lift assist factors.

Additional stability for the mower 1 while in maintenance position may be achieved with the addition of a screw jack integrated into the underside of the mower 1. The screw jack may be positioned at the approximate side-to-side center of the mower 1, and may be rotated into position between a raised mower 1 and the ground to raise or provide additional support for a raised mower 1. If provided, the screw jack is angled such that the screw jack is generally vertical when in the raised position.

The rearward pivoting assembly 2 has many benefits and advantages including, but not limited to improved operator ride, improved access to maintenance areas, and reducing service time and labor along with inherent safety measures. The disclosed design improves safety by shifting the majority of the weight of the mower 1 to the rear wheels 102 with approximately 80 percent of the weight on the rear wheels 102 and approximately 20 percent on the front wheels 108. These and other benefits and advantages of the rearward pivoting assembly 2 design are apparent from the specification and claims.

In an alternative embodiment, the rearward pivoting seat assembly 2 may be modified to allow similar functionality for a stand-on vehicle 1. A rearward pivoting assembly for a stand-on vehicle 1 may comprise an engine enclosure secured to a frame of the stand-on vehicle 1. An operator station may be secured to the engine enclosure or mainframe at a pivot point behind the engine. The operator station may be a standing or alternate position platform with its associated controls. When pivoted rearwardly, the rearward pivoting assembly for a stand-on vehicle 1 moves the center of gravity 110 of the stand-on vehicle 1 behind the rear wheel axis of the stand-on vehicle 1 to allow tilting the front of the stand-on vehicle 1 upward for servicing components on the underside of the stand-on vehicle 1.

The rearward pivoting assembly for a stand-on vehicle 1, when pivoted rearward, moves a center of gravity 110 of the stand-on vehicle 1 nearly above a rear wheel axis of the stand-on vehicle 1 to allow tilting a front of the stand-on vehicle 1 upward for servicing one or more front wheels, an underside of a deck of the stand-on vehicle, 1 and one or more cutting blades of the stand-on vehicle 1. The rearward pivoting assembly for a stand-on vehicle 1, when pivoted rearward, improves access to servicing one or more of a transaxle, a drive belt, pulleys, springs, operating controls, linkages, battery, wiring, an engine, electric motor, or a fuel system of the stand-on vehicle 1.

### Formed and Welded Frame for a Transaxle Driven Vehicle 1

In some embodiments, the mower frame 101 may be formed from sheet metal with C-shaped channel and an offset height feature. The mower frame 101 may be fabricated from one sheet of steel cut and formed from the back to the front. The lowest portion of the mower frame 101 has edges facing one another from the right and left side rail, having a surface parallel and aligned for mounting the transaxle 103. The vertical portion of each side of the mower deck 101 has a common height suitable for controls and mounting features. The top surface of the mower deck 101 is offset lower with a series of 45 degree bends to achieve proper height of the engine 105 mount. The top surface of the mower deck 101 also has a number of features for mounting controls, belt pulley and tensioner. The front portion of the mower frame 101 relative to the purpose of this embodiment has deck 107 mounting and locating support of the mower deck 107 height. Multiple cross members of sheet metal are cut and formed to be welded to add mounting features and maintain rigidity of the primary frame.

The frame 101 with its one-piece profile provides a low center of gravity 110 of the engine 105 and other items above it, even the operator station embodiment. The engine 105, which could be substituted with electric battery and motor(s), has a significant contribution to the overall weight and performance of the vehicle 1. The lower center of gravity 110 results in greater stability on slopes, reducing the risk of tipping the vehicle 1 while operating on sloped terrain.

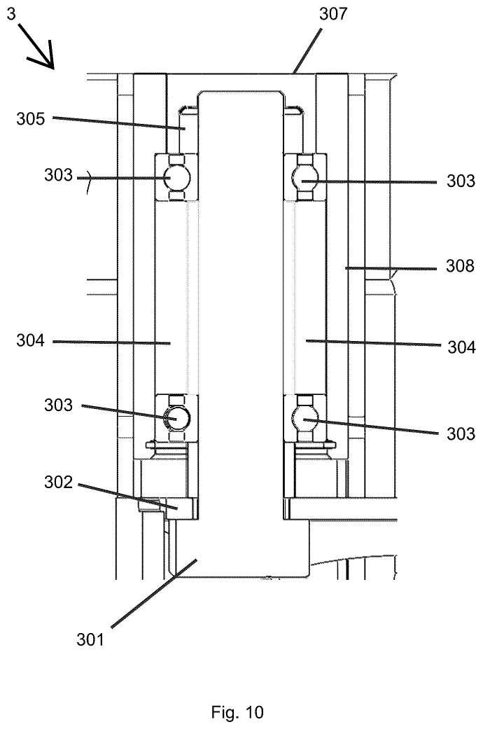

As shown in FIG. 10, the front of frame 101 can be welded or bolted to a front wheel 108 spindle caster wheel assembly 3 structure with fixed or pivoting functions. The spindle caster wheel assembly 3 provides a permanent sheet metal cap that is advantageous as caps are commonly damaged or popped off, which allows water, dirt, and other debris to enter the bearings. The caster wheel assembly 3 has a tube for yoke assembly allowing 360 degrees rotation through the use of bushings or bearings 303. It is desirable to have proper fit of bearings 303 to the shaft 301 and tube 308, while allowing serviceability for replacement of bearing 303 or spindle. To have a permanent cap, retention is achieved as follows. The first or lower bearing 303 shoulders up to the tube 308 with a moderate fit. A washer 302 may be placed between the shaft 301 and the first or lower bearing 303. A snap ring or spacer 304 above it may be used to retain the shaft. A u-cup seal common for grease seals or cylinder rods with a rubber or Viton lip or a thin-profile nylon-insert nut 305 disposed above the upper bearing 303 against the shaft 301 and tube 308 is used for resistance to rotation and sliding. The spacer 304 extends between the lower bearing 303 and the upper bearing 303 and are held in place by the nut 305. Multiples of the spacer 304 can be used in the space allotted or resistance desired. The top of the spindle having a bearing 303 of smaller inner diameter and outer diameter is the secondary rotational bearing with limited vertical load requirements. An optional set screw or cotter pin may be used against the lower bearing outer race adjacent to the top plate of frame weldment 307 for redundancy to the fit. The spindle caster wheel assembly 3 is held in the machined housing 308 with a snap ring under the bottom bearing 303 and another spacer under the bearing 303.

The front wheel 108 spindle and bearing assembly is therefore assembled with fewer components and smaller hardware, and does not need access to the top for removal or retention in the frame.

A front caster wheel assembly 3 incorporated into the frame 101 may have a machine tube 308 of various inside diameters and top welded to the underside of the top sheet metal of the frame 101. The tube 308 may have machined surfaces with the largest diameter in the lowest portion of vertical orientation to provide a tight fit for a bearing 303. A smaller diameter provides clearance to a spacer tube and the top having machined inside diameters (id) for slip fit of the bearing 303 and a final id for retainer clearance. The caster wheel 108 of common design with a properly proportioned and rating for the machine 1 having a horizontal axis with idler bearings retained in a yoke with a shaft or bolt in common practice. The yoke continues vertical to a vertical shaft ahead of the caster wheel 108 axis. The shaft 301 with an outside diameter (od) near the diameter of the lower bearing 303 inner race is machined to a diameter and finish suitable for compression fit of the lower bearing 303, a looser fit for a spacer 304 above, another smaller bearing 303 fit, also a retaining feature either threaded for a locknut or cotter-pin 306 hole. The vertical shaft 301 bearings assembly being somewhat compressed before installation is installed into the vertical tube 308 of the frame 101 weldment with press fit and a set screw on the lower bearing 303. This eliminates a top nut and thrust washer(s) above the frame 101 further requiring sealing devices or covers to prevent moisture intrusion.

The riding mower chassis may comprise a fabricated mower frame 101 with a primary shape determining length, width and height of the frame with an offset to align multiple pulleys at the lowest configuration possible.

The spindle tube is shown with the spindle assembly bearings and minimal retaining hardware.

What is claimed:

1. A rearward pivoting assembly for a vehicle comprising:
an engine enclosure secured to a frame of the vehicle; and
a seat frame secured to the engine enclosure at a pivot axis behind a seat and engine of the vehicle the seat frame comprising a first side and a second side wherein the first side and second side are generally parallel to each other, a seat frame front surface having a first edge connected to an edge of the first side of the seat frame and a second edge connected to an edge of the second side of the seat frame such that the seat frame front surface is generally perpendicular to the first side and the second side of the seat frame, and a generally horizontal platform for mounting an operator seat, the generally horizontal platform extending forwardly from the seat frame front surface;
wherein a rearmost position of the seat frame is secured to the engine enclosure at a pivot axis disposed at an uppermost and rearmost position of the engine enclosure; and
wherein the seat frame may rotate rearwardly about the pivot axis, placing the vehicle in a stable maintenance position wherein a front end of the vehicle is raised.

2. The rearward pivoting assembly of claim 1 wherein a front end of the generally horizontal platform rests on a shock absorber under a front portion of the operator seat.

3. The rearward pivoting assembly of claim 1 wherein a front end of the seat frame is secured with a latch, hook, or tether in an operating position.

4. The rearward pivoting assembly of claim 1 further comprising a foot platform, wherein the foot platform comprises a generally horizontal surface, a rear pivot axis of the foot platform connecting to a front pivot axis of the generally horizontal platform of the seat frame and extending forwardly.

5. The rearward pivoting assembly of claim 4 wherein a front end of the foot platform secures to a frame of the vehicle with a latch, hook, or tether in the operating position.

6. The rearward pivoting assembly of claim 1 wherein the engine enclosure comprises a first side and a second side wherein the first side and second side are mounted to a frame of the vehicle and are generally parallel to each other, an engine enclosure back surface having a first edge connected to an edge of the first side of the engine enclosure and a second edge connected to an edge of the second side of the engine enclosure such that the engine enclosure back surface is generally perpendicular to the first side and the second side of the engine enclosure, and wherein the first side, second side, and engine enclosure back surface of the engine enclosure are formed from a single piece of material.

7. The rearward pivoting assembly of claim 1 further comprising a safety interlock configured to disrupt operation of the vehicle when the seat frame is rotated rearwardly.

8. A frame for a mower suitable for lowering the center of gravity of the mower comprising: a sheet metal profile with C-shaped channel sides and offset height features fabricated from one sheet of steel cut and formed from a back end of each C-shaped channel to a front end of each C-shaped channel, wherein a lowest portion of the frame has edges facing one another from a right side rail and a left side rail, the right side rail and the left side rail each having a surface parallel to a transaxle of the mower and aligned for mounting the transaxle, a vertical portion of each C-shaped channel side has a common height suitable for controls and mounting features, and atop surface of a middle portion of the frame is offset lower with a series of 45 degree bends.

9. A rearward pivoting assembly for a stand-on vehicle comprising:
an engine enclosure secured to a frame of the stand-on vehicle; and
an operator station secured to the engine enclosure a pivot point behind an engine of the stand-on vehicle, the operator station comprising a standing platform and controls;
wherein the operator station may rotate rearwardly about the pivot point, placing the stand-on vehicle in a stable maintenance position wherein a front end of the stand-on vehicle is raised.
